(19) United States
(12) Patent Application Publication
(10) Pub. No.: US 2026/0046323 A1
(43) Pub. Date: Feb. 12, 2026

(54) METHOD AND DEVICE FOR SUPPORTING COMMUNICATION BY USING SATELLITE IN WIRELESS COMMUNICATION SYSTEM

(71) Applicant: Samsung Electronics Co., Ltd., Suwon-si (KR)

(72) Inventors: Jaehyeon BAE, Suwon-si (KR); Dongyeon KIM, Suwon-si (KR); Jicheol LEE, Suwon-si (KR); Hoyeon LEE, Suwon-si (KR)

(21) Appl. No.: 19/292,389

(22) Filed: Aug. 6, 2025

(30) Foreign Application Priority Data
Aug. 9, 2024 (KR) 10-2024-0107162
Oct. 4, 2024 (KR) 10-2024-0134801

(51) Int. Cl. H04L 65/1069; H04L 65/1016; H04L 65/1045; H04W 80/10

(52) U.S. Cl. CPC H04L 65/1069; H04L 65/1016; H04L 65/1045; H04W 80/10

(57) ABSTRACT

A method performed by a 5G or 6G communication system for supporting a higher data transmission rate is provided. The method includes receiving a first message from a first user equipment (UE), receiving satellite-related information from a policy and charging rules function/policy control function (PCRF/PCF) by using the first message, performing a resource update of the first UE by using the satellite-related information, transmitting the first message including information on the resource update to the first UE, receiving an acknowledgement (ACK) message for the first message from the UE, and updating the ACK message and transmitting the updated ACK message to a second UE.

### CROSS-REFERENCE TO RELATED APPLICATION(S)

This application is based on and claims priority under 35 U.S.C. § 119(a) of a Korean patent application number 10-2024-0107162, filed on Aug. 9, 2024, in the Korean Intellectual Property Office, and of a Korean patent application number 10-2024-0134801, filed on Oct. 4, 2024, in the Korean Intellectual Property Office, the disclosure of each of which is incorporated by reference herein in its entirety.

### BACKGROUND

### 1. Field

The disclosure relates to a terminal communication service using a satellite.

### 2. Description of Related Art

Fifth generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) use equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

An Internet protocol (IP) multimedia subsystem (IMS) system is a system for transmitting IP-based multimedia, and various services, such as voice over long-term evolution (VoLTE) and voice over new radio (VoNR) are provided through the existing IMS network linked to LTE or 5G networks.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and a device for receiving, from an evolved packed core (EPC)/5G core (5GC), information related to a change in IMS AGW or UPF information within a satellite due to movement of the satellite, after establishing an IMS voice and video service session between terminals using the satellite, and/or for delivering updated information related to a currently connected IMS voice and video service session (e.g., updated/changed information on an AGW currently serving a terminal) to a peer network according to movement of the satellite.

Another aspect of the disclosure is to provide a method and a device for delivering changed IMS session configuration information due to movement of a satellite supporting a corresponding terminal in order to provide an IMS voice or video service between terminals using the satellite.

Additional aspects will be set forth in part in the description which follows and, in part, will be apparent from the description, or may be learned by practice of the presented embodiments.

In accordance with another aspect of the disclosure, a method of a first network entity supporting communication using a satellite in a wireless communication system including a first user equipment (UE) and a second UE is provided. The method includes receiving a first message from the first UE, receiving satellite-related information from a policy and charging rules function/policy control function (PCRF/PCF) by using the first message, performing a resource update of the first UE by using the satellite-related information, transmitting the first message including information on the resource update to the first UE, receiving an acknowledgement (ACK) message for the first message from the first UE, and updating the ACK message and transmitting the updated ACK message to the second UE.

In accordance with another aspect of the disclosure, a device of a first network entity supporting communication using a satellite in a wireless communication system including a first user equipment (UE) and a second UE is provided. The device includes a transceiver, and a processor coupled with the transceiver and configured to control the transceiver to receive a first message from the first UE, receive satellite-related information from a policy and charging rules function/policy control function (PCRF/PCF) by using the first message, perform a resource update of the first UE by using the satellite-related information, transmit the first message including information on the resource update to the first UE, receive an acknowledgement (ACK) message for the first message from the first UE, and update the ACK message and transmit the updated ACK message to the second UE.

In accordance with another aspect of the disclosure, one or more non-transitory computer-readable storage media storing one or more computer programs including computer-executable instructions that, when executed by individually or collectively by at least one processor of a device of a first network entity supporting communication using a satellite in a wireless communication system comprising a first user equipment (UE) and a second UE to perform operations are provided. The operations include receiving a first message from the first UE, receiving satellite-related information from a policy and charging rules function/policy control function (PCRF/PCF) by using the first message, performing a resource update of the first UE by using the satellite-related information, transmitting the first message comprising information on the resource update to the first UE, receiving an acknowledgement (ACK) message for the first message from the UE, and updating the ACK message and transmitting the updated ACK message to the second UE.

In accordance with another aspect of the disclosure, a method of a proxy call session control function (P-CSCF) entity in an Internet protocol (IP) multimedia subsystem (IMS) service is provided. The method includes receiving, from a user equipment (UE) or an IMS-AS, an IMS session connection request message (SIP INVITE or SIP Re-INVITE) including information (a UE-to-UE communication support indication through a satellite connection, i.e., UE-SAT-UE communication support indication) for supporting UE-to-UE communication through a satellite connection (UE-SAT-UE communication) and session description protocol (SDP) offer information, requesting, from a PCRF/PCF, satellite-related information for supporting UE-to-UE communication through a satellite connection, based on UE-SAT-UE communication support indication information and a Bootstrap ID, receiving satellite-related information (e.g., satellite ID, UPF information, and access gateway (AGW) information) for supporting the UE from the PCRF/PCF, determining whether to request a subscription for satellite change information from an EPC/5GC, based on the satellite-related information (e.g., AGW information) received from the PCRF/PCF and the information (UE-SAT-UE communication support indication) received from the UE or the IMS-AS, delivering, to the PCRF or the PCF, related information for requesting a subscription to satellite change-related information, determining, by the EPC or the 5GC, whether a satellite has changed, and in case that the satellite supporting the UE has changed, receiving notification information (event notification and updated satellite information) related to a change in information on the satellite serving the corresponding UE, in case that the notification information includes information related to the changed satellite, determining a change (e.g., AGW relocation or reselection) in an IMS entity supporting an IMS service being used by the UE, delivering AGW information supporting a peer UE to a newly selected AGW through an AGW change or reselection operation, and delivering information for requesting AGW information within the changed satellite supporting the corresponding UE, delivering, to the UE or an I/S-CSCF, an SIP message including information on an indication (Re-INVITE request indication) for requesting transmission of an SIP Re-INVITE message according to a policy or a configuration of a service provider, updating an SDP offer including updated or changed AGW information according to movement of the satellite, and included within the SIP Re-INVITE message received from the UE, and delivering the SIP Re-INVITE message including the modified SDP offer to a terminating-side network and UE through the I/S-CSCF.

According to a method and a device according to an embodiment of the disclosure, it is possible to perform a satellite change event subscription request operation on an EPC or a 5GC when a change occurs in an IMS entity supporting an IMS voice or video service, due to movement of a satellite supporting a terminal, while an IMS voice or video service using a satellite connection between terminals is in use, and perform an IMS session update operation for configuring an IMS voice or video service by delivering changed IMS session-related information including changed IMS session entity information (e.g., AGW) to a terminating-side network, based on satellite change notification information received from an EPC or a 5GC.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a network structure and an interface of a 5G system according to an embodiment of the disclosure;

FIG. 2 illustrates a structure for supporting an IMS voice or video service through a satellite according to an embodiment of the disclosure;

FIG. 3A is a flowchart illustrating an IMS registration and IMS session connection request operation for a terminal to use an IMS service using a satellite according to an embodiment of the disclosure;

FIG. 3B is a flowchart illustrating an IMS registration and IMS session connection request operation for a terminal to use an IMS service using a satellite according to an embodiment of the disclosure;

FIG. 4 is a flowchart illustrating an IMS session connection update operation considering movement of a satellite while a terminal uses an IMS service using a satellite, according to an embodiment of the disclosure;

FIG. 5A is a flowchart illustrating an IMS session connection update operation considering movement of a satellite while a terminal uses an IMS service using a satellite, according to an embodiment of the disclosure;

FIG. 5B is a flowchart illustrating an IMS session connection update operation considering movement of a satellite while a terminal uses an IMS service using a satellite, according to an embodiment of the disclosure;

FIG. 5C is a flowchart illustrating an IMS session connection update operation considering movement of a satellite while a terminal uses an IMS service using a satellite, according to an embodiment of the disclosure;

FIG. 6 is a flowchart illustrating an IMS session connection update operation considering movement of a satellite while a terminal uses an IMS service using a satellite, according to an embodiment of the disclosure;

FIG. 7 is a flowchart illustrating an operation of an entity according to an embodiment of the disclosure;

FIG. 8 is a block diagram illustrating an entity device according to an embodiment of the disclosure; and

FIG. 9 is a block diagram illustrating a UE device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the disclosure, descriptions related to technical contents well-known in the art and not associated directly with the disclosure will be omitted. Such an omission of unnecessary descriptions is intended to prevent obscuring of the main idea of the disclosure and more clearly transfer the main idea. In addition, the terms which will be described below are terms defined based on the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

In the following description, a base station is an entity that allocates resources to terminals, and may be at least one of a gNode B, an eNode B, a Node B (or xNode B (where, x is an alphabet including g or e)), a wireless access unit, a base station controller, a satellite, an airborne, and a node on a network. A user equipment (UE) may include a mobile station (MS), a vehicular, a satellite, an airborne, a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Additionally, a “sidelink (SL)” may exist, which refers to a radio link via which a UE transmits a signal to another UE.

Furthermore, in the following description, LTE or LTE-A systems may be described by way of example, but the embodiments of the disclosure may also be applied to other communication systems having similar technical backgrounds or channel types. For example, 5G-Advance, NR-Advance, or 6^{th} generation (6G) mobile communication technologies developed beyond 5G mobile communication technologies (or new radio (NR)) may be included therein, and in the following description, the “5G” may be the concept that covers the exiting LTE, LTE-A, or other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

The 3^{rd} generation partnership project (3GPP), which manages cellular mobile communication standards, has introduced a new core network structure referred to as 5G core (5GC) and has been standardizing the 5GC in order to push evolution from a fourth generation long term evolution (4G LTE) system to a 5G system. 5GC supports the following distinguishable functions, compared to an evolved packet core (EPC), which is a network core for 4G.

5GC adopts a network slicing function. As a requirement of 5G, 5GC is required to support various types of UEs and services, e.g., enhanced mobile broadband (eMBB), ultra reliable low latency communications (URLLC), and massive machine type communications (mMTC). Such UEs/services have different requirements for the core network. For example, the eMBB service may require a high data rate, and the URLLC service may require high stability and low latency. The network slicing technology has been proposed to meet such various service requirements.

Network slicing may refer to a method for creating multiple logical networks (e.g., network slices) by virtualizing one physical network. An activated network slice may be referred to as a network slice instance, and each network slice instance (NSI) may have a different characteristic. A mobile communication service provider may configure a network function (NF) suitable for the characteristic of each NSI so as to meet various service requirements according to UEs/services. For example, the mobile communication service provider may allocate an NSI suitable for the characteristic of a service required for each UE, so as to efficiently support several 5G services (e.g., eMBB, URLLC, or mMTC).

5GC may seamlessly support a network virtualization paradigm through separation of a mobility management function and a session management function. In 4G LTE, all UEs may receive services from a network through signaling exchange with a single core entity which is referred to as a mobility management entity (MME) in charge of registration, authentication, mobility management, and session management functions. In 5G, the number of UEs (including, e.g., MTC UEs) has exponentially increased and mobility and traffic/session characteristics required to be supported according to the type of UE are subdivided. Accordingly, if all functions are supported by a single entity (e.g., MME), the scalability of adding an entity for each required function may inevitably decrease. Therefore, various functions are being developed based on a structure of separating a mobility management function and a session management function in order to improve the scalability in terms of function/implementation complexity and signaling load of a core entity in charge of a control plane.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

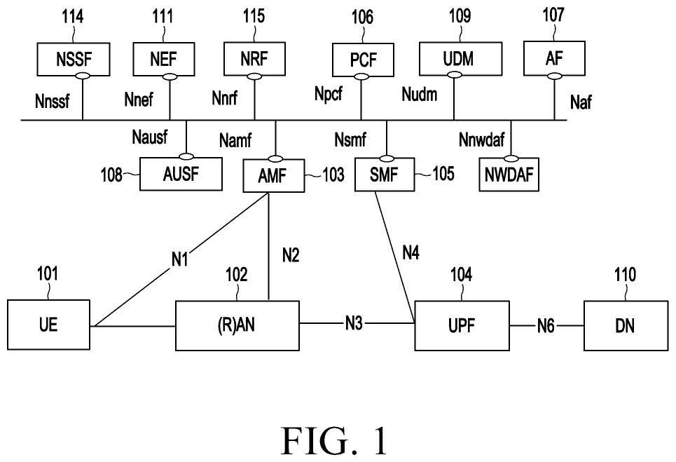

FIG. 1 is a diagram illustrating a network structure and an interface of a 5G system according to an embodiment of the disclosure.

A network entity included in a network structure of a 5G system in FIG. 1 may include a network function (NF) depending on system implementation.

Referring to FIG. 1, the network structure of the 5G system may include various network entities. For example, the 5G system may include an authentication server function (AUSF) entity 108, a (core) access and mobility management function (AMF) entity 103, a session management function (SMF) entity 105, a policy control function (PCF) entity 106, an application function (AF) entity 107, a unified data management (UDM) entity 109, a data network (DN) 110, a network exposure function (NEF) entity 111, a network slicing selection function (NSSF) entity 114, a network repository function (NRF) entity 115, a network data analytics function (NWDAF), an edge application service domain repository (EDR), an edge application server (EAS), an EAS discovery function (EASDF), a user plane function (UPF) entity 104, a (radio) access network ((R)AN) 102, and a terminal, e.g., a user equipment (UE) 101.

The respective NF entities of the 5G system 100 may support the following functions.

The AUSF 108 may process and store data for authentication of the UE 101.

The AMF 103 may provide a function for access and mobility management in the unit of a UE, and one UE may be basically connected to one AMF. Specifically, the AMF 103 may support functions, such as inter-CN node signaling for mobility between 3GPP access networks, termination of a radio access network (RAN) CP interface (i.e., an N2 interface), termination (N1) of non-access stratum (NAS) signaling, NAS signaling security (NAS ciphering and integrity protection), AS security control, registration management (registration area management), connection management, idle mode UE reachability (including control and performance of paging retransmission), mobility management control (subscription and policies), support of intra-system mobility and inter-system mobility, support of network slicing, SMF selection, lawful interception (for an AMF event and an interface for an LI system), provision of delivery of session management (SM) messages between the UE and the SMF, a transparent proxy for routing SM messages, access authentication, access authorization including a roaming right check, provision of delivery of SMS messages between the UE and an SMSF, a security anchor function (SAF), and/or a security context management (SCM). Some or all functions of the AMF entity 103 may be supported in a single instance of one AMF entity.

The DN 110 may refer to, for example, an operator service, an Internet access or 3rd party service, or the like. The DN 110 may transmit a downlink protocol data unit (PDU) to the UPF entity 104, or receive a PDU transmitted from the UE 101 from the UPF entity 104.

The PCF entity 106 may receive information on a packet flow from an application server to provide a function of determining policies, such as mobility management and session management. Specifically, the PCF entity 106 may support functions, such as support of a unified policy framework for controlling a network operation, provision of a policy rule to enable control plane function entity(s) (e.g., the AMF entity, the SMF entity, or the like) to execute the policy rule, and implementation of a front end (FE) for accessing relevant subscription information for policy determination in a user data repository (UDR).

The SMF entity 105 may provide a session management function, and when the UE 101 has multiple sessions, the respective sessions may be managed by different SMF entities. Specifically, the SMF entity 105 may support functions, such as session management (e.g., session establishment, modification, and release, including tunnel maintenance between nodes of the UPF entity 140 and the (R)AN 102), UE IP address allocation and management (including selective authentication), selection and control of a UP function, configuration of traffic steering at the UPF entity 104 to route traffic to a proper destination, termination of an interface toward policy control functions (PCFs), execution of a control part of a policy and a quality of service (QoS), lawful interception (for an SM event and an interface to an LI system), termination of a session management (SM) part of an NAS message, downlink data notification, an initiator of access network (AN)-specific SM information (delivered to the (R)AN 102 through N2 via the AMF entity 103), determination of a session and service continuity (SSC) mode of a session, and a roaming function. Some or all functions of the SMF entity 105 may be supported in a single instance of one SMF entity.

The UDM entity 109 may store user subscription data, policy data, or the like. The UDM entity 109 may include two parts, that is, an application front end (FE) and a user data repository (UDR).

The FE may include a UDM FE in charge of location management, subscription management, and credential processing, and a PCF entity in charge of policy control. The UDR may store data required for functions provided by the UDM-FE, and a policy profile required by the PCF entity. The data stored in the UDR may include policy data and user subscription data including a subscription identifier, a security credential, access and mobility-related subscription data, and session-related subscription data. The UDM-FE may access subscription information stored in the UDR, and support functions, such as authentication credential processing, user identification handling, access authentication, registration/mobility management, subscription management, and SMS management.

The UPF entity 104 may deliver a downlink PDU received from the DN 110 to the UE 101 via the (R)AN 102, and deliver an uplink PDU received from the UE 101 to the DN 110 via the (R)AN 102. Specifically, the UPF entity 104 may support functions, such as an anchor point for intra/inter-RAT mobility, an external PDU session point of interconnection to a data network, packet routing and forwarding, a user plane part of packet inspection and policy rule enforcement, lawful interception, traffic usage reporting, an uplink classifier for supporting routing of traffic flows to a data network, a branching point for supporting a multi-homed PDU session, QoS handling for a user plane (e.g., packet filtering, gating, and uplink/downlink rate enforcement), uplink traffic verification (a service data flow (SDF) mapping between an SDF and a QoS flow), transport level packet marking in an uplink and a downlink, and a downlink packet buffering and downlink data notification triggering function. Some or all functions of the UPF entity 104 may be supported in a single instance of one UPF entity.

The AF entity 107 may interact with a 3GPP core network for service provision (e.g., support for functions, such as application influence on traffic routing, access to network capability exposure, and interaction with a policy framework for policy control).

The (R)AN (102) may collectively refer to a new radio access network supporting both an evolved E-UTRA, which is an evolved version of 4G radio access technology, and a new radio access technology (new radio: NR) (e.g., a gNB).

The gNB may support functions, such as functions for radio resource management (that is, radio bearer control, radio admission control, connection mobility control, and dynamic allocation of resources to the UE in an uplink/downlink (that is, scheduling)), Internet protocol (IP) header compression, encryption and integrity protection of a user data stream, selection of the AMF during UE attachment when routing to the AMF is not determined based on information provided by the UE, routing of user plane data to the UPF(s), routing of control plane information to the AMF, connection setup and release, scheduling and transmission of paging messages (generated by the AMF), scheduling and transmission of system broadcast information (generated by the AMF or operating and maintenance (O&M)), measurement and measurement reporting configuration for mobility and scheduling, transport level packet marking in an uplink, session management, support of network slicing, QoS flow management and mapping to a data radio bearer, support of the UE in an inactive mode, a NAS message distribution function, a NAS node selection function, sharing of a radio access network, dual connectivity, and tight interworking between NR and E-UTRA.

The UE 101 may indicate a user device. The UE may be referred to as a terminal, a mobile equipment (ME), a mobile station (MS) or the like. In addition, the UE may be a portable device, such as a notebook, a mobile phone, a personal digital assistant (PDA), a smartphone, or a multimedia device, or an unportable device, such as a personal computer (PC) or a vehicle-mounted device.

The NEF 111 may provide a means for securely exposing services and capabilities provided by 3GPP network functions, for example, for a 3rd party, internal exposure/re-exposure, application function, and edge computing. The NEF 111 may receive information (based on exposed capability(s) of other NF(s)) from the other NF(s). The NEF 111 may store received information as structured data by using a standardized interface as a data storage network function. The stored information may be re-exposed to other NF entity(s) and AF entity(s) by the NEF entity 111, and may be used for other purposes, such as analysis.

The EASDF may be an NF that is capable of adding, for each fully qualified domain name (FQDN), an address of a domain name system (DNS) server to which a DNS request from a terminal is to be forwarded, and an extension mechanisms for DNS (EDNS) client subnet (ECS) option representable by an IP subnet address required to be added when the DNS request from the terminal is forwarded. The EASDF may receive exchange active sync (EAS) domain configuration information from the EDR, and process a DNS request message received from the terminal, according to the received information. In addition, the EASDF may be an NF that performs a function of receiving, from the SMF 105, a terminal IP address, location information of the terminal in 3GPP, a DNS message handling rule, and a DNS message reporting rule, processing a DNS query message received from the terminal and a DNS response message received from a DNS server, and transmitting, according to the DNS message reporting rule, information in a DNS message and statistical information obtained by processing the same to the SMF 105.

The NRF 115 may support a service discovery function. The NRF may receive an NF discovery request from an NF instance, and provide information on discovered NF instances to the NF instance. In addition, the NRF may maintain available NF instances and services supported thereby.

FIG. 1 illustrates, for convenience of explanation, a reference model in which the UE 101 accesses the one DN 110 by using one PDU session, but the disclosure is not limited thereto.

The UE 101 may concurrently access two (that is, local and central) data networks by using multiple PDU sessions. In this case, two SMFs may be selected for different PDU sessions. However, each SMF may have a capability of controlling both a local UPF and a central UPF in a PDU session.

In addition, the UE 101 may concurrently access two (that is, local and central) data networks provided in a single PDU session.

In 3GPP systems, conceptual links connecting NFs in the 5G system may be defined as “reference points”. As an example, reference points included in the 5G system 100 of FIG. 1 are as follows.
N1: a reference point between a UE 101 and an AMF 103
N2: a reference point between an (R)AN 102 and an AMF 103
N3: a reference point between an (R)AN 102 and a UPF 104
N4: a reference point between an SMF 105 and a UPF 104
N5: a reference point between a PCF 106 and an AF 107
N6: a reference point between a UPF 104 and a DN 110
N7: a reference point between an SMF 105 and a PCF 106
N8: a reference point between a UDM 109 and an AMF 103
N10: a reference point between a UDM 109 and an SMF 105
N11: a reference point between an AMF 103 and an SMF 105
N12: a reference point between an AMF 103 and an AUSF 108
N13: a reference point between a UDM 109 and an AUSF 108
N14: a reference point between two AMFs 103
N15: a reference point between a PCF and an AMF for a non-roaming scenario, and a reference point between a PCF and an AMF in a visited network for a roaming scenario
Nx: a reference point between an SMF 105 and an EASDF
Ny: a reference point between an NEF (EDF) 111 and an EASDF

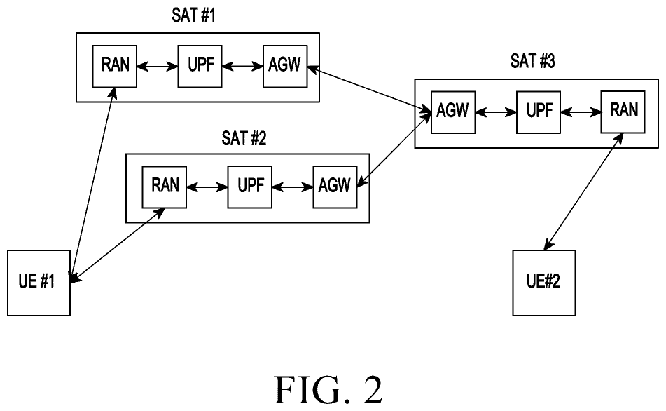

FIG. 2 illustrates an example of a structure for supporting an IMS voice or video service through a satellite according to an embodiment of the disclosure.

UE #1 and UE #2 may perform UE-to-UE communication through a satellite (sat). For example, the satellite may include at least one of a RAN, a UPF, or an access gateway (AGW) for supporting an IMS voice or video service. The satellite may include at least one of satellite #1 (SAT #1), satellite #2 (SAT #2), or satellite #3 (SAT #3). At least one of a mobility management entity (MME) or an access and mobility management function (AMF) may be included. If an AGW exists within the satellite, each UE using an IMS voice or video service may be connected to a peer UE and a satellite supporting the corresponding UE through the AGW within the satellite. According to an embodiment of the disclosure, each UE may be connected through a different satellite. In FIG. 2, UE #1 uses satellite #1 (SAT #1), and UE #2 uses satellite #3 (SAT #3), so that each UE may use a direct communication service using a satellite without a connection to a separate ground station. In FIG. 2, other network entities which constitute the existing 5GC, such as an AMF, a PSA UPF, and an SMF, which are not included within the satellite, may be located on the ground. In addition, network entities which constitute an IMS, such as a P-CSCF, an I/S-CSCF, and an IMS AS which constitute an IMS network, may also be located on the ground. A UE may first perform a registration procedure and PDU session generation request process within IMS 5G through the satellite. To this end, the UE may perform direct communication through the RAN within the satellite of FIG. 2, and the RAN within the satellite may perform a 5GC registration and PDU session establishment procedure requested by the UE by using other 5GC network entities within a ground station. After the PDU session establishment procedure is completed, the UE may perform a registration process of the UE within the IMS network by transmitting an SIP Register message to the IMS network. After the registration procedure of the UE within the IMS network, the UE may perform an IMS voice or video service connection procedure by delivering an SIP INVITE message for a connection request for the IMS voice or video service to the IMS network and a peer UE (UE #2). According to an embodiment of the disclosure, when each UE performs a UE registration procedure in the IMS network, each UE may include the type of network to which the UE is connected in a session initiation protocol (SIP) message header, and deliver the message header to the IMS network. If each UE has registered with the IMS network through the satellite, the IMS network (e.g., IMS AS) may determine whether to support an IMS voice or video service between the corresponding UEs through a direct UE-to-UE connection via the satellite, based on information delivered in the SIP message header delivered by the UE. If the IMS voice or video service is to be supported through the direct UE-to-UE connection via the satellite, service support indication (UE-SAT-UE communication support indication) information may be included in an SDP offer and delivered to each UE and a CSCF. An originating-side network supporting UE #1 according to an embodiment of the disclosure may refer to a visited IMS entity (e.g., V-P-CSCF) when a UE accesses the IMS network through a visited network.

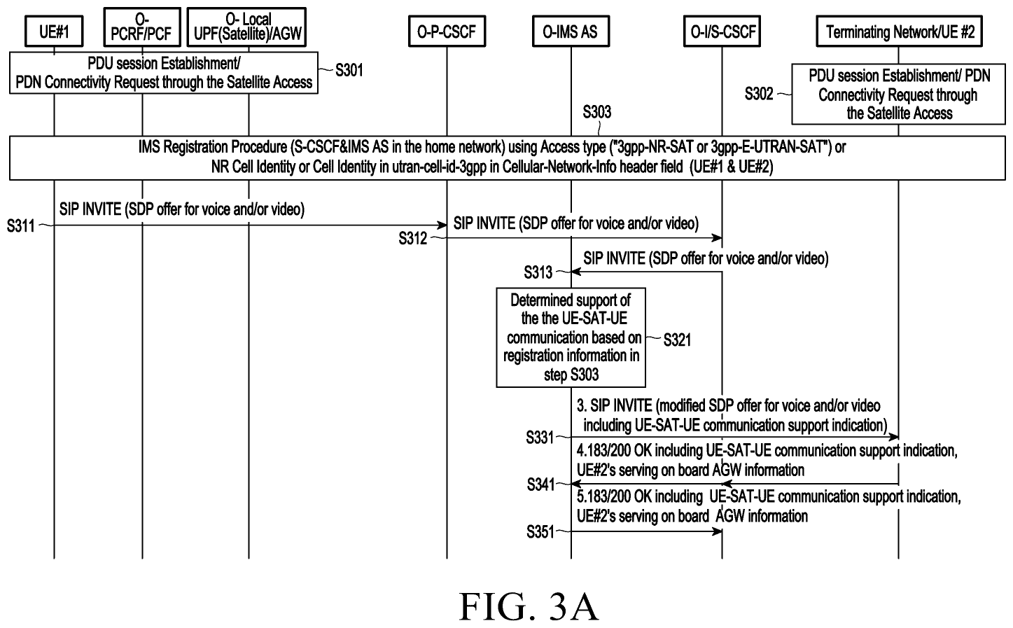

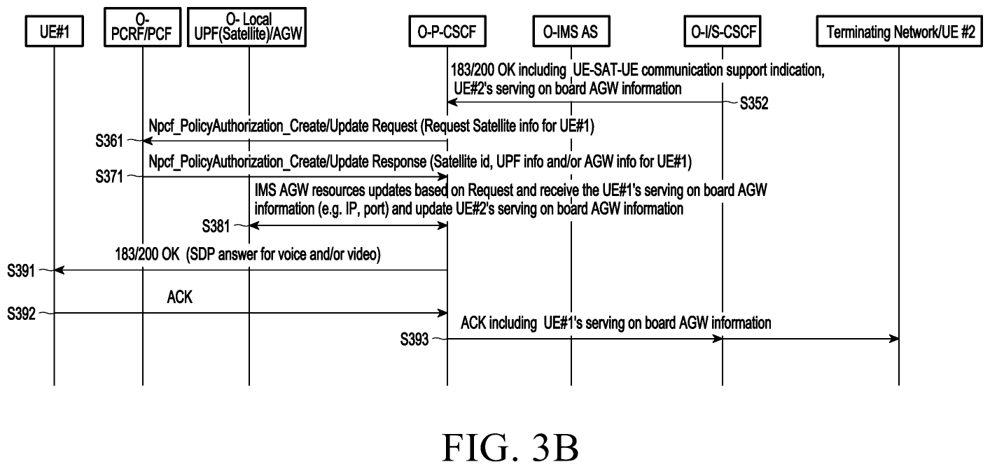

FIG. 3A is a flowchart illustrating an IMS registration and IMS session connection request operation for a UE to use an IMS service using a satellite according to an embodiment of the disclosure.

FIG. 3B is a flowchart illustrating an IMS registration and IMS session connection request operation for a UE to use an IMS service using a satellite according to an embodiment of the disclosure.

Referring to FIGS. 3A and 3B, in operation S301, a UE (UE #1) may perform a session establishment operation (PDU session establishment or PDN connectivity procedure) within an EPC or 5GC through a RAN (E-UTRAN or NG-RAN) within a satellite. In operation S302, a UE (UE #2) may perform the session establishment operation (PDU session establishment or PDN connectivity procedure) within the EPC or 5GC through the RAN (E-UTRAN or NG-RAN) within the satellite.

In operation S303, each UE (UE #1 and/or UE #2) may perform an IMS network registration procedure by using an SIP Register message after a PDU session or PDN connection operation is completed. Through an SIP message header (Cellular-Network-Info header field) including the SIP Register message, each UE (UE #1 and/or UE #2) may deliver information on an access type of each UE (Access type: “3gpp-NR-SAT” or “3gpp-E-UTRAN-SAT”), or through cell information within the utran-cell-id-3gpp (e.g., NR cell identity or E-UTRAN cell identity (ECI)), each UE may deliver, to an IMS network (e.g., an S-CSCF or an IMS application server (AS) (telephony application server (TAS)), that each UE has performed the IMS network registration procedure using a satellite connection.

In operation S311, UE #1 may generate an SIP INVITE message including audio or video-related SDP offer information for a request for an IMS voice or video service connection, and deliver the SIP INVITE message to an IMS AS (TAS) through a P-CSCF and an I/S-CSCF. A P-CSCF entity may be referred to as a first entity. In operation S312, the first entity may transmit the SIP INVITE message to an I/S-CSCF entity. The I/S-CSCF entity may be referred to as a second entity. In operation S313, the second entity may transmit the SIP INVITE message to the IMS AS.

In operation S321, the IMS AS (TAS), which has received the request for the IMS voice or video service connection from the UE, may be aware that UE #1 and/or UE #2 have registered with the IMS network through the satellite, based on information on a caller (UE #1) and a callee (UE #2) (e.g., Caller ID and Callee ID or UE #1 & UE #2's MSISDN). The IMS AS (TAS) may determine whether a UE-to-UE communication service using the satellite is available when establishing an IMS voice and video service between UE #1 and UE #2, based on UE #1 and UE #2 being registered with the IMS network through the satellite and subscription information of each user obtained from an HSS and configuration and policy information of a service provider. If the UE-to-UE communication service using the satellite between UE #1 and UE #2 can be supported based on IMS service connection request information (information on a caller (UE #1) and a callee (UE #2)) received from UE #1 and the subscription information of each user, related information (UE-SAT-UE communication indication) may be included in the SIP message. The IMS AS may recognize that UE #1 uses an IMS service through a satellite connection, based on information (Access type or Cell ID, or the like) in the SIP header received when UE #1 performs the registration procedure in the IMS network. Thereafter, when there is no UE-to-UE communication service support indication (UE-SAT-UE communication support indication) in an IMS service connection request message (SIP INVITE or SIP re-INVITE) received from UE #1, the IMS AS may add a UE-to-UE communication service support indication (UE-SAT-UE communication support indication) to the IMS service connection request message (SIP INVITE or SIP re-INVITE) in order to check whether the UE-to-UE communication service is supported by a peer network and UE. In addition, originating and terminating-side P-CSCFs may determine whether to perform an AGW resource update operation and an operation of requesting AGW information within a corresponding satellite, based on UE-to-UE communication service support indication (UE-SAT-UE communication support indication) information in an SIP message (SIP INVITE or re-INVITE or 200 OK), so as to perform a related operation. If an originating-side IMS AS adds the UE-to-UE communication service support indication (UE-SAT-UE communication support indication) to an SIP message (SIP INVITE or re-INVITE) and delivers the SIP message, but a terminating-side network delivers an SIP message (SIP 183 or 200 OK) which does not include the UE-to-UE communication service support indication (UE-SAT-UE communication support indication), the originating-side IMS AS may recognize that the terminating-side network and a UE cannot use a UE-to-UE communication service, and may perform an IMS service connection operation using a ground station.

In operation S331, the originating-side IMS AS may deliver an SIP INVITE message including a UE-to-UE communication service support indication using a satellite (UE-SAT-UE communication indication) to the terminating-side network and UE #2.

The terminating-side P-CSCF, which has received the SIP INVITE message including the UE-to-UE communication service support indication using the satellite (UE-SAT-UE communication indication), may request and receive satellite-related information for supporting direct communication using the satellite from a terminating PCRF/PCF (T-PCRF/PCF), based on information on the UE-to-UE communication service support indication using the satellite. The satellite-related information received from the T-PCRF/PCF may include at least one piece of satellite-related information for supporting a corresponding UE (e.g., UE #2), among a Satellite ID, UPF information, and AGW information (e.g., IP address or IP range, port, or the like). The T-P-CSCF may perform a resource update operation within AGW information in a satellite supporting UE #2, based on satellite-related information received through the EPC or 5GC. Through the resource update operation, the T-P-CSCF may receive AGW information (e.g., IP address or IP range, port, or the like) supporting UE #2 from an AGW.

In operation S341, the T-P-CSCF may deliver, to an originating-side network, a 183 progress or 200 OK message including the UE-SAT-UE communication support indication and the AGW information (e.g., IP address or IP range, port, or the like) supporting UE #2. In other words, UE #2 may transmit the 183 progress or 200 OK message to the I/S-CSCF. The I/S-CSCF may transmit the 183 progress or 200 OK message to the IMS AS.

In operation S351, the IMS AS may transmit the 183 progress or 200 OK message to the I/S-CSCF.

In operation S352, an originating-side I/S-CSCF, which has received the 183 progress or 200 OK message including the UE-SAT-UE communication support indication and the AGW information (e.g., IP address or IP range, port, or the like) supporting UE #2 from the terminating-side network, may deliver the message to the P-CSCF.

In operation S361, the P-CSCF, which has received the 183 progress or 200 OK message including information on the UE-to-UE communication service support indication using the satellite (UE-SAT-UE communication support indication) through operation S352, may request satellite-related information for supporting the corresponding UE #1 from an originating-side PCRF/PCF. The request message may include the corresponding UE-related information (e.g., a UE IP range or a UE location).

In operation S371, the originating-side PCRF/PCF may deliver satellite-related information for supporting UE #1 to the P-CSCF. The satellite-related information received from the PCRF/PCF may include at least one piece of satellite-related information for supporting a corresponding UE (e.g., UE #1), among a Satellite ID, UPF information, and AGW information (e.g., IP address or IP range, port, or the like).

In operation S381, the originating-side P-CSCF may perform a resource update operation on an AGW supporting UE #1, based on the information received in operation S371. Through the resource update operation process, the P-CSCF may deliver AGW information related to UE #2 received from the terminating-side network, and receive AGW information related to UE #1.

In operation S391, the P-CSCF, which has completed the resource update operation of the AGW related to UE #1, may deliver the 183 progress or 200 OK message to the UE (UE #1).

In S392, UE #1 may deliver an ACK message related to the 183 progress or 200 OK message received in operation S391 to the P-CSCF.

In operation S393, the originating-side P-CSCF may update the ACK message including information of the AGW supporting UE #1 through operation S381 and then deliver the updated ACK message to the terminating-side network.

The determination in operation S321 of whether to support the UE-to-UE communication service using the satellite may be made by the IMS-AS based on subscriber information and network access type information of each UE when each UE is within the same PLMN. If UEs are users belonging to different PLMNs, the IMS AS of the originating-side network may determine whether to support the UE-to-UE communication service using the satellite, based on subscriber information and network access type information of UE #1, and may generate information on the UE-to-UE communication service support indication using the satellite (UE-SAT-UE communication support indication), based on the information of UE #1, and deliver the generated information to the terminating-side network and UE #2. The terminating-side network may determine whether to support a UE-to-UE communication service using a satellite for UE #2, based on subscriber information and network access information (e.g., Access type or Cell identity) of UE #2. If the UE-to-UE communication service using the satellite is not available based on the subscriber information of UE #2, the terminating-side IMS AS may delete the information on the UE-to-UE communication service support indication using the satellite (UE-SAT-UE communication support indication) from the SIP INVITE message received from the originating-side network, and then deliver the modified SIP INVITE message to UE #2. When there is no information on the UE-to-UE communication service support indication using the satellite (UE-SAT-UE communication support indication) in the 183 progress or 200 OK message received from the terminating-side network and UE #2, the originating-side network (e.g., IMS AS) may determine that the UE-to-UE communication service using the satellite cannot be supported by UE #2 and the terminating-side network. Thereafter, UE #1 and UE #2 may perform an IMS session connection operation to use an IMS service through an AGW in a ground station (base station).

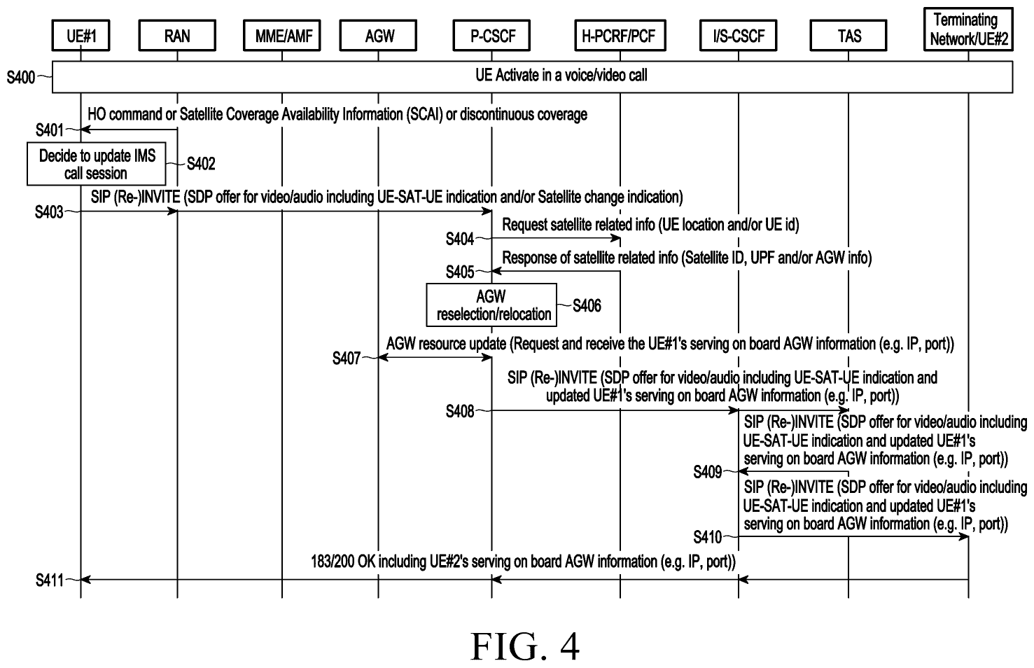

FIG. 4 is a flowchart illustrating an IMS session connection update operation considering movement of a satellite while a UE uses an IMS service using a satellite, according to an embodiment of the disclosure.

According to an embodiment of the disclosure, when a UE-to-UE communication service using a satellite (e.g., an IMS voice or video service) is used, a procedure for changing an IMS entity within the satellite (on board AGW relocation) due to movement of the satellite may be performed.

In operation S400, each UE (UE #1 and UE #2) may request an IMS voice or video service connection and execute an IMS voice or video call through a UE-to-UE communication service using a satellite.

In operation S401, a RAN (e.g., E-UTRAN or NG-RAN) within the satellite may deliver satellite change-related command or information to a UE. The satellite change-related command or information delivered to the UE may include one or more pieces of information among a handover command, satellite coverage availability information (SCAI), and discontinuous coverage information. The UE may determine whether to change a satellite serving the UE, based on the satellite change-related command or information received in operation S401. The satellite change-related command or information may be delivered to the UE from an MME or an AMF within the satellite.

In operation S402, it may be determined whether to perform an IMS session update operation based on IMS session establishment information and the satellite change-related command or information from the satellite in operation S400. In operation S400, the IMS session establishment information may include information on a UE-to-UE communication service support indication using the satellite (UE-SAT-UE communication support indication). The UE may be aware that the UE uses a direct communication service using the satellite, based on the information on the UE-to-UE communication service support indication using the satellite (UE-SAT-UE communication support indication), and when receiving the satellite change-related command or information in operation S401, the UE may determine to perform an IMS session update operation for supporting an IMS network entity change (AGW relocation) operation. In order to perform the IMS session update operation, the UE may determine to perform an operation of transmitting an SIP (Re-) INVITE message including at least one piece of information among the information on the UE-to-UE communication service support indication using the satellite (UE-SAT-UE communication support indication) and a satellite change indication.

In operation S403, a UE (UE #1) may deliver an SIP (Re-) INVITE message including at least one piece of information among the information on the UE-to-UE communication service support indication using the satellite (UE-SAT-UE communication support indication) and the satellite change indication to a P-CSCF in a ground station through the RAN within the satellite.

In operation S404, the P-CSCF, which has received the SIP (Re-)INVITE message including at least one piece of information among the information on the UE-to-UE communication service support indication using the satellite (UE-SAT-UE communication support indication) and the satellite change indication, may request, from a PCRF or a PCF, delivery of satellite-related information for supporting the corresponding UE (request satellite related information). The P-CSCF may deliver UE-related information (e.g., UE location info or UE id or UE MSISDN) to the PCRF or the PCF in order to request satellite-related information (e.g., Satellite ID, and UPF and/or AGW information) for supporting the UE.

In operation S405, the PCRF or the PCF may deliver satellite information (e.g., Satellite ID, and UPF and/or AGW information) for supporting the corresponding UE to the P-CSCF, based on the UE-related information (e.g., UE location info or UE id or UE MSISDN) received in operation S404.

In operation S406, the P-CSCF may compare the satellite-related information (e.g., Satellite ID, and UPF and/or AGW information) for supporting the corresponding UE, received in operation S405, with the existing satellite information for supporting the corresponding UE, and determine to perform an AGW change operation (relocation or reselection) if the satellite information has been changed. If the P-CSCF does not receive a separate satellite change indication from the UE in operation S403, the P-CSCF may perform an operation of requesting delivery of satellite information related to the corresponding UE and receiving satellite-related information whenever an SIP (Re-) INVITE message is delivered to the PCRF or the PCF, based on the information on the UE-to-UE communication service support indication using the satellite (UE-SAT-UE communication support indication).

In operation S407, if the P-CSCF has determined and decided to change an AGW due to a change of a satellite supporting the UE (UE #1) in operation S406, the P-CSCF may perform an AGW resource update request operation on an AGW within the changed satellite. The P-CSCF may receive, from the changed AGW, resource allocation information (e.g., IP address or port, or the like) within the AGW for supporting an IMS service of UE #1.

In operation S408, the P-CSCF may add updated or changed AGW resource information, due to the change of the satellite supporting the UE (UE #1), to the SIP (Re-) INVITE message received from the UE in operation S403, and deliver the changed or updated SIP (Re-) INVITE message to a terminating-side IMS AS (T-IMS AS).

In operation S409, the IMS AS (T-IMS AS) may transmit, to an I/S-CSCF, the changed AGW resource information, based on the updated or changed AGW resource information due to the change of the satellite supporting the UE (UE #1), received from the P-CSCF.

In operation S410, the I/S-CSCF may deliver the changed AGW resource information to a terminating-side network and UE #2, based on the updated or changed AGW resource information due to the change of the satellite supporting the UE (UE #1).

A terminating-side P-CSCF, which has received, from an originating-side network, the updated or changed AGW resource information (e.g., IP address or IP range, port, or the like) due to the change of the satellite supporting UE #1, may request information on a satellite supporting UE #2 from a terminating-side PCRF or PCF, and receive satellite-related information for supporting UE #2 from the PCRF or the PCF. If the P-CSCF determines, based on the information received from the PCRF or the PCF, that the satellite supporting UE #2 has not changed, the P-CSCF may deliver UE #1-related AGW resource information delivered from the originating side, and perform a connection configuration operation between an AGW supporting UE #2 and an AGW within the changed satellite supporting UE #1. If the satellite supporting UE #2 has changed based on the information received from the PCRF or the PCF, the terminating-side P-CSCF may determine to perform an AGW change operation related to UE #2, based on the satellite-related information received from the terminating-side PCRF or PCF. Thereafter, the P-CSCF may request the changed AGW to deliver the UE #1-related AGW resource information received from the originating-side network, and to deliver the updated AGW information supporting UE #2 due to the change of the satellite.

In operation S411, depending on whether the satellite supporting UE #2 has changed, if the information on the satellite supporting UE #2 has been changed, the terminating-side network may deliver a 183 Progress or 200 OK message including AGW information within the changed satellite supporting UE #2 to the originating-side network. If the 183 Progress or 200 OK message delivered from the terminating-side network includes the changed AGW information supporting UE #2, an originating-side P-CSCF may deliver the changed AGW information supporting UE #2 to the AGW within the satellite supporting UE #1 through an AGW resource update operation. Thereafter, the originating-side P-CSCF may deliver the 183 Progress or 200 OK message to UE #1, so as to complete the performance of the IMS session update operation due to the change of the satellite.

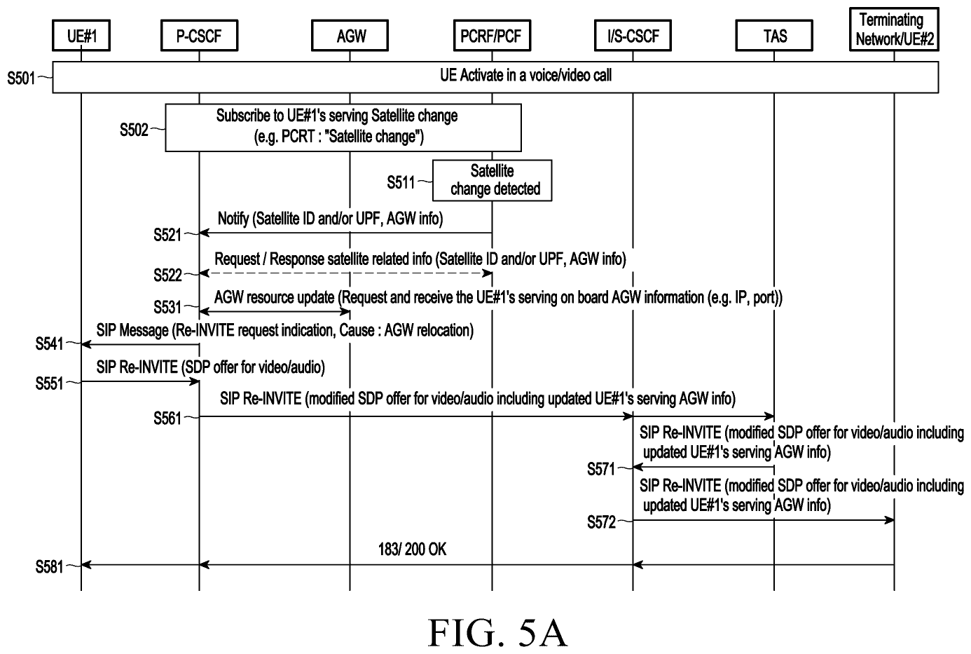

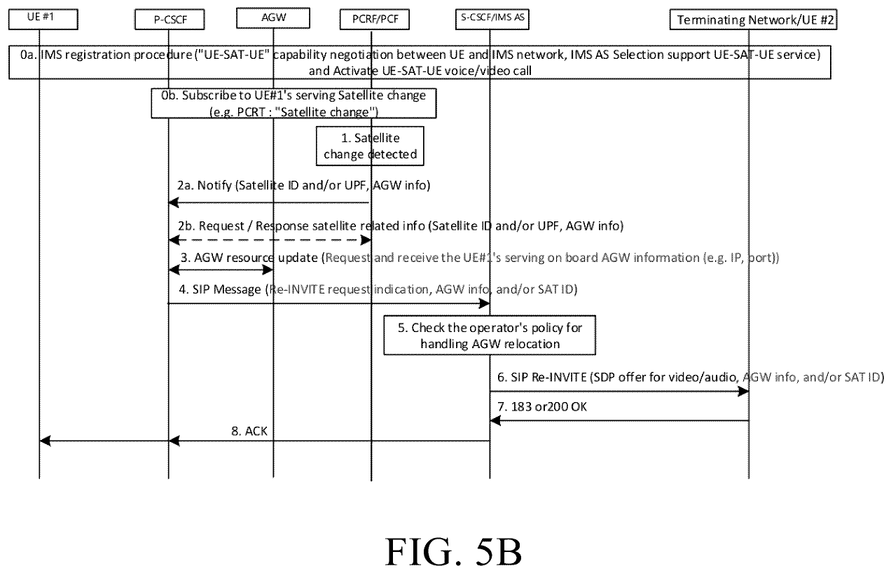

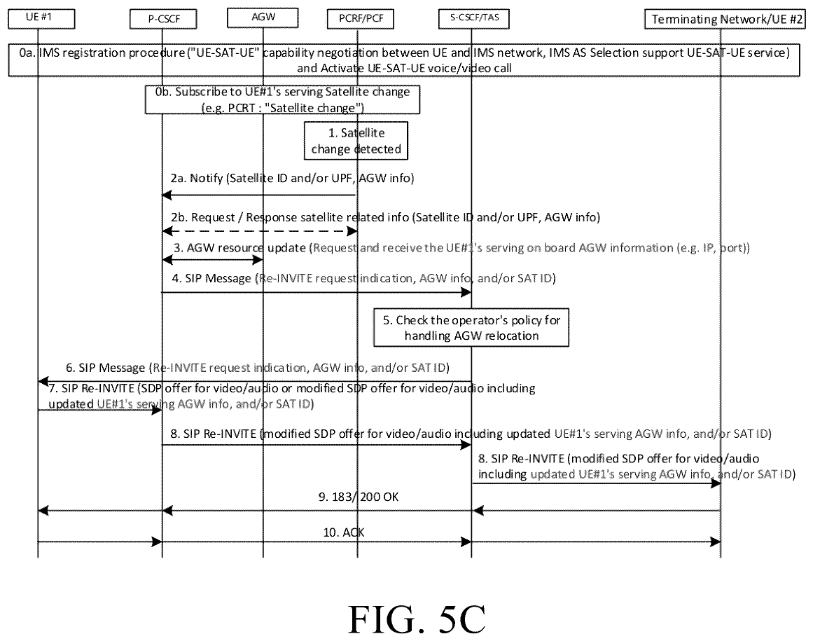

FIG. 5A is a flowchart illustrating an IMS session connection update operation considering movement of a satellite while a UE uses an IMS service using a satellite, according to an embodiment of the disclosure.

According to an embodiment of the disclosure, when a UE-to-UE communication service using a satellite (e.g., an IMS voice or video service) is used, a procedure for changing an IMS entity within the satellite (on board AGW relocation) due to movement of the satellite may be performed. A P-CSCF may deliver, to a PCRF or a PCF, a subscription request for information on a change of a satellite supporting a UE due to the movement of the satellite, so that when the satellite supporting the UE is changed by an AMF or an MME, the corresponding satellite change event occurrence information may be notified to the P-CSCF through the PCRF or the PCF.

In operation S501, each UE (UE #1 and UE #2) may request an IMS voice or video service connection and execute an IMS voice or video call through a UE-to-UE communication service using a satellite.

In operation S502, the P-CSCF, which has received information on a UE-to-UE communication service support indication using a satellite (UE-SAT-UE communication support indication) from a UE or an IMS AS (TAS) while performing an IMS service connection operation, may deliver a satellite change-related event subscription request (e.g., policy control request trigger (PCRT): “Satellite Change”) to the PCRF or the PCF.

In operation S511, depending on movement of the satellite, the PCRF or the PCF may detect a change of a satellite supporting UE #1, based on satellite change-related information (e.g., Satellite ID) received from the AMF or the MME. The UE may perform a mobility registration update (MRU), tracking area update (TAU), or service request (SR) operation to perform a connection to a new satellite supporting the UE depending on the movement of the satellite, and thus notify the AMF or the MME that a change of the satellite related to the UE has occurred. According to an embodiment of the disclosure, after receiving subscription request information of satellite change information from the P-CSCF, the PCF may deliver a policy control request trigger (PCRT) related to satellite change information to an SMF or the AMF, and when a PCRT condition (e.g., satellite change) is satisfied, the PCF may receive, from the SMF or the AMF, whether a corresponding event (a change of the satellite serving the UE) has occurred.

If, in operation S502, the P-CSCF has performed a subscription for a change event of the satellite supporting UE #1 to the PCRF or the PCF, the PCRF or the PCF may notify the P-CSCF of the satellite change event received from the AMF or the MME.

In operation S521, a notification message delivered from the PCRF or the PCF may include whether a satellite change event has occurred and changed satellite-related information. If the notification message delivered from the PCRF or the PCF includes the changed satellite-related information in operation S521, operation S522 may be omitted. In operation S522, the P-CSCF, which has received the notification message including only whether a satellite change event has occurred, may request information on the changed satellite supporting UE #1 (e.g., Satellite ID, and UPF and/or AGW information) from the PCRF or the PCF, based on UE #1-related information, and the PCRF or the PCF may deliver the information on the changed satellite supporting UE #1 (e.g., Satellite ID, and UPF and/or AGW information) to the P-CSCF.

In operation S531, the P-CSCF may perform an AGW resource update request operation on an AGW within the changed satellite, based on notification information on a change event of a satellite supporting a UE (UE #1) and information on a change of the satellite supporting the UE in operations S521 and S522. The P-CSCF may receive, from the changed AGW, resource allocation information (e.g., IP address or port, or the like) within the AGW for supporting an IMS service of UE #1.

In operation S541, the P-CSCF may deliver, to the UE, an SIP message including indication information (Re-INVITE request indication) and cause information (Cause: AGW relocation) for requesting the UE to transmit an SIP Re-INVITE message for delivering, to a terminating-side network, AGW resource allocation information (e.g., IP address or port, or the like) within the changed satellite for supporting the IMS service of UE #1 due to the change of the satellite supporting UE #1.

In operation S551, the UE (UE #1) may include, in the SIP Re-INVITE message, an SDP offer including information related to the IMS service currently in service, and deliver the message to the P-CSCF.

In operation S561, the P-CSCF, which has received, from the UE, the SIP Re-INVITE message including the SDP offer including the information related to the IMS service currently in service, may add AGW information (e.g., updated UE #1's serving AGW information) within the changed satellite for supporting the IMS service of UE #1 to the SIP Re-INVITE message, and deliver the message to the IMS AS (TAS) via an I/S-CSCF.

In operation S571, the IMS AS (TAS), which has received, from the P-CSCF, the SIP Re-INVITE message including the AGW information (e.g., updated UE #1's serving AGW information) within the changed satellite for supporting the IMS service of UE #1, may transmit the corresponding SIP Re-INVITE message to the IS/-CSCF. In operation S572, the IS/-CSCF may deliver the SIP Re-INVITE message to the terminating-side network and a UE (UE #2).

A terminating-side P-CSCF, which has received, from an originating-side network, the updated or changed AGW resource information (e.g., IP address or IP range, port, or the like) due to the change of the satellite supporting UE #1, may request information on a satellite supporting UE #2 from a terminating-side PCRF or PCF, and receive satellite-related information for supporting UE #2 from the PCRF or the PCF. If the terminating-side P-CSCF determines, based on the information received from the PCRF or the PCF, that the satellite supporting UE #2 has not changed, the terminating-side P-CSCF may deliver UE #1-related AGW resource information delivered from the originating side, and perform a connection configuration operation between an AGW supporting UE #2 and an AGW within the changed satellite supporting UE #1. If the satellite supporting UE #2 has changed based on the information received from the PCRF or the PCF, the terminating-side P-CSCF may determine to perform an AGW change operation related to UE #2, based on the satellite-related information received from the terminating-side PCRF or PCF. Thereafter, the terminating-side P-CSCF may request the changed AGW to deliver the UE #1-related AGW resource information received from the originating-side network, and to deliver the updated AGW information supporting UE #2 due to the change of the satellite.

In operation S581, depending on whether the satellite supporting UE #2 has changed, if the information on the satellite supporting UE #2 has been changed, the terminating-side network may deliver a 183 Progress or 200 OK message including AGW information within the changed satellite supporting UE #2 to the originating-side network. If the 183 Progress or 200 OK message delivered from the terminating-side network includes the changed AGW information supporting UE #2, an originating-side P-CSCF may deliver the changed AGW information supporting UE #2 to the AGW within the satellite supporting UE #1 through an AGW resource update operation. Thereafter, the originating-side P-CSCF may deliver the 183 Progress or 200 OK message to UE #1, so as to complete the performance of an IMS session update operation due to the change of the satellite.

FIG. 5B is a flowchart illustrating an IMS session connection update operation considering movement of a satellite while a UE uses an IMS service using a satellite, according to an embodiment of the disclosure.

According to an embodiment of the disclosure, when a UE-to-UE communication service using a satellite (e.g., an IMS voice or video service) is used, a procedure for changing an IMS entity within the satellite (on board AGW relocation) due to movement of the satellite may be performed. A P-CSCF may deliver, to a PCRF or a PCF, a subscription request for information on a change of a satellite supporting a UE due to the movement of the satellite, so that when the satellite supporting the UE is changed by an AMF or an MME, the corresponding satellite change event occurrence information may be notified to the P-CSCF through the PCRF or the PCF.

In operation 0a, each UE (UE #1 and UE #2) may execute an IMS voice or video call through IMS registration and an IMS voice or video service connection request for a UE-to-UE communication service using a satellite. Each UE (UE #1 and UE #2) may include UE-SAT-UE capability information in a Feature-Caps header field within an SIP Registration message header during an IMS registration procedure, and deliver the same to the P-CSCF and an S-CSCF. During the IMS registration procedure, in a 3^{rd}-party registration operation for IMS AS selection, when a UE having UE-SAT-UE capability connects, the S-CSCF may select, in addition to the existing TAS server supporting voice and video calls, an IMS AS (e.g., STAS, Satellite-supported telephony application server (TAS)) supporting UE-SAT-UE using a satellite, that is, direct satellite-to-satellite communication. Thereafter, depending on the characteristics of a call requested by the UE, the S-CSCF may deliver an IMS session connection request message requested by the UE to an appropriate IMS AS (e.g., TAS or STAS) so that audio and video calls using the existing IMS network are processed by the existing TAS, and audio and video calls through direct satellite-to-satellite communication are processed by an STAS supporting direct satellite-to-satellite communication. Through the procedure, the UE may execute an IMS voice or video call through the selected IMS AS (e.g., TAS or STAS) depending on the characteristics of the call requested by the UE.

In operation 0b, the P-CSCF, which has received information on a UE-to-UE communication service support indication using a satellite (UE-SAT-UE communication support indication) from the UE or an IMS AS (TAS) while performing an IMS service connection operation, may deliver a satellite change-related event subscription request (e.g., policy control request trigger (PCRT): “Satellite Change”) to the PCRF or the PCF.

In operation 1, depending on movement of the satellite, the PCRF or the PCF may detect a change of a satellite supporting UE #1, based on satellite change-related information (e.g., Satellite ID) received from the AMF or the MME. The UE may perform a mobility registration update (MRU), tracking area update (TAU), or service request (SR) operation to perform a connection to a new satellite supporting the UE depending on the movement of the satellite, and thus notify the AMF or the MME that a change of the satellite related to the UE has occurred. According to an embodiment of the disclosure, after receiving subscription request information of satellite change information from the P-CSCF, the PCF may deliver a policy control request trigger (PCRT) related to satellite change information to an SMF or the AMF, and when a PCRT condition (e.g., satellite change) is satisfied, the PCF may receive, from the SMF or the AMF, whether a corresponding event (a change of the satellite serving the UE) has occurred.

If, in operation 2a, the P-CSCF has performed a subscription for a change event of the satellite supporting UE #1 to the PCRF or the PCF, the PCRF or the PCF may notify the P-CSCF of the satellite change event received from the AMF or the MME.

In operation 2b, a notification message delivered from the PCRF or the PCF may include whether a satellite change event has occurred and changed satellite-related information. If the notification message delivered from the PCRF or the PCF includes the changed satellite-related information in operation S521, operation S521 may be omitted. In operation 2b, the P-CSCF, which has received the notification message including only whether a satellite change event has occurred, may request information on the changed satellite supporting UE #1 (e.g., Satellite ID, and UPF and/or AGW information) from the PCRF or the PCF, based on UE #1-related information, and the PCRF or the PCF may deliver the information on the changed satellite supporting UE #1 (e.g., Satellite ID, and UPF and/or AGW information) to the P-CSCF.

In operation 3, the P-CSCF may perform an AGW resource update request operation on an AGW within the changed satellite, based on notification information on a change event of a satellite supporting a UE (UE #1) and information on a change of the satellite supporting the UE in operations 2a and 2b. The P-CSCF may receive, from the changed AGW, resource allocation information (e.g., IP address or port, or the like) within the AGW for supporting an IMS service of UE #1.

In operation 4, the P-CSCF may deliver, to the S-CSCF and the IMS AS (e.g., STAS), an SIP message including at least one of indication information (Re-INVITE request indication), changed AGW resource (e.g., IP address or port, or the like), and/or a SAT ID in order to request the IMS AS (e.g., STAS) to transmit an SIP Re-INVITE message for delivering, to a terminating-side network, AGW resource allocation information (e.g., IP address or port, or the like) within the changed satellite for supporting the IMS service of UE #1 due to the change of the satellite supporting UE #1.

In operation 5, the IMS AS, which has received, from the P-CSCF, an SIP Re-INVITE message request for delivering the AGW resource allocation information within the changed satellite to the terminating-side network, may determine an AGW resource change processing method based on the policy of a service provider. If the IMS AS may support an SIP message generation and transmission operation for directly transmitting an SIP re-INVITE request message of the P-CSCF, and the corresponding service provider allows the corresponding operation (an operation of generating an SIP Re-INVITE message in the IMS AS) within the policy of the service provider, the IMS AS may determine an operation for delivering the SIP re-INVITE message including at least one piece of information among the changed AGW resource (e.g., IP address or port, or the like) and/or the SAT ID received from the P-CSCF to the terminating-side network and/or UE #2.

In operation 6, the IMS AS may transmit the SIP Re-INVITE message including AGW information within the changed satellite related to UE #1 (e.g., updated UE #1's serving AGW information) to an IS/-CSCF. The IS/-CSCF may deliver the SIP Re-INVITE message to the terminating-side network and a UE (UE #2). The AGW information within the changed satellite may include at least one piece of information among an AGW resource (e.g., IP address or port, or the like), and/or a SAT ID.

A terminating-side P-CSCF, which has received, from an originating-side network, the updated or changed AGW resource information (e.g., IP address or IP range, port, or the like) due to the change of the satellite supporting UE #1, may request information on a satellite supporting UE #2 from a terminating-side PCRF or PCF, and receive satellite-related information for supporting UE #2 from the PCRF or the PCF. If the terminating-side P-CSCF determines, based on the information received from the PCRF or the PCF, that the satellite supporting UE #2 has not changed, the terminating-side P-CSCF may deliver UE #1-related AGW resource information delivered from the originating side, and perform a connection configuration operation between an AGW supporting UE #2 and an AGW within the changed satellite supporting UE #1. If the satellite supporting UE #2 has changed based on the information received from the PCRF or the PCF, the terminating-side P-CSCF may determine to perform an AGW change operation related to UE #2, based on the satellite-related information received from the terminating-side PCRF or PCF. Thereafter, the terminating-side P-CSCF may request the changed AGW to deliver the changed UE #1-related AGW resource information received from the originating-side network, and to deliver the updated AGW information supporting UE #2 due to the change of the satellite.

In operation 7, depending on whether the satellite supporting UE #2 has changed, if the information on the satellite supporting UE #2 has been changed, the terminating-side network may deliver a 183 Progress or 200 OK message including AGW information within the changed satellite supporting UE #2 to the originating-side network. If the 183 Progress or 200 OK message delivered from the terminating-side network includes the changed AGW information supporting UE #2, an originating-side IMS AS may determine to generate a Re-INVITE message for delivering the changed AGW supporting UE #2 to an originating-side P-CSCF. Thereafter, the originating-side IMS AS may deliver the SIP Re-INVITE message including the changed AGW information supporting UE #2 to the P-CSCF, so that the changed AGW information supporting UE #2, received from the terminating-side network, may be delivered to the AGW within the satellite supporting UE #1 through an AGW resource update operation. Thereafter, the originating-side P-CSCF or UE may deliver the 183 Progress or 200 OK message to the IMS AS to perform an IMS session update operation due to the change of the satellite.

In operation 8, based on the SIP re-INVITE message delivered in operation 6, the originating-side IMS AS may notify the UE (UE #1) that a related resource update operation in an AGW of UE #2 has been completed in the terminating-side network based on UE #1-related AGW information, and thus the IMS session update operation has been successfully performed. The information may be delivered from the IMS AS to UE #1 through an SIP message or an ACK message.

FIG. 5C is a flowchart illustrating an IMS session connection update operation considering movement of a satellite while a UE uses an IMS service using a satellite, according to an embodiment of the disclosure. According to an embodiment of the disclosure, when a UE-to-UE communication service using a satellite (e.g., an IMS voice or video service) is used, a procedure for changing an IMS entity within the satellite (on board AGW relocation) due to movement of the satellite may be performed. A P-CSCF may deliver, to a PCRF or a PCF, a subscription request for information on a change of a satellite supporting a UE due to the movement of the satellite, so that when the satellite supporting the UE is changed by an AMF or an MME, the corresponding satellite change event occurrence information may be notified to the P-CSCF through the PCRF or the PCF.

In operation 0a, each UE (UE #1 and UE #2) may execute an IMS voice or video call through IMS registration and an IMS voice or video service connection request for a UE-to-UE communication service using a satellite. Each UE (UE #1 and UE #2) may include UE-SAT-UE capability information in a Feature-Caps header field within an SIP Registration message header during an IMS registration procedure, and deliver the same to the P-CSCF and an S-CSCF. During the IMS registration procedure, in a 3^{rd}-party registration operation for IMS AS selection, when a UE having UE-SAT-UE capability connects, the S-CSCF may select, in addition to the existing TAS server supporting voice and video calls, an IMS AS (e.g., STAS, Satellite-supported telephony application server (TAS)) supporting UE-SAT-UE using a satellite, that is, direct satellite-to-satellite communication. Thereafter, depending on the characteristics of a call requested by the UE, the S-CSCF may deliver an IMS session connection request message requested by the UE to an appropriate IMS AS (e.g., TAS or STAS) so that audio and video calls using the existing IMS network are processed by the existing TAS, and audio and video calls through direct satellite-to-satellite communication are processed by an STAS supporting direct satellite-to-satellite communication. Through the procedure, the UE may execute an IMS voice or video call through the selected IMS AS (e.g., TAS or STAS) depending on the characteristics of the call requested by the UE.

In operation 0b, the P-CSCF, which has received information on a UE-to-UE communication service support indication using a satellite (UE-SAT-UE communication support indication) from the UE or an IMS AS (TAS) while performing an IMS service connection operation, may deliver a satellite change-related event subscription request (e.g., policy control request trigger (PCRT): “Satellite Change”) to the PCRF or the PCF.

In operation 1, depending on movement of the satellite, the PCRF or the PCF may detect a change of a satellite supporting UE #1, based on satellite change-related information (e.g., Satellite ID) received from the AMF or the MME. The UE may perform a mobility registration update (MRU), tracking area update (TAU), or service request (SR) operation to perform a connection to a new satellite supporting the UE depending on the movement of the satellite, and thus notify the AMF or the MME that a change of the satellite related to the UE has occurred. According to an embodiment of the disclosure, after receiving subscription request information of satellite change information from the P-CSCF, the PCF may deliver a policy control request trigger (PCRT) related to satellite change information to an SMF or the AMF, and when a PCRT condition (e.g., satellite change) is satisfied, the PCF may receive, from the SMF or the AMF, whether a corresponding event (a change of the satellite serving the UE) has occurred.

If, in operation 2a, the P-CSCF has performed a subscription for a change event of the satellite supporting UE #1 to the PCRF or the PCF, the PCRF or the PCF may notify the P-CSCF of the satellite change event received from the AMF or the MME.

In operation 2b, a notification message delivered from the PCRF or the PCF may include whether a satellite change event has occurred and changed satellite-related information. If the notification message delivered from the PCRF or the PCF includes the changed satellite-related information in operation S521, operation S521 may be omitted. In operation 2b, the P-CSCF, which has received the notification message including only whether a satellite change event has occurred, may request information on the changed satellite supporting UE #1 (e.g., Satellite ID, and UPF and/or AGW information) from the PCRF or the PCF, based on UE #1-related information, and the PCRF or the PCF may deliver the information on the changed satellite supporting UE #1 (e.g., Satellite ID, and UPF and/or AGW information) to the P-CSCF.

In operation 3, the P-CSCF may perform an AGW resource update request operation on an AGW within the changed satellite, based on notification information on a change event of a satellite supporting a UE (UE #1) and information on a change of the satellite supporting the UE in operations 2a and 2b. The P-CSCF may receive, from the changed AGW, resource allocation information (e.g., IP address or port, or the like) within the AGW for supporting an IMS service of UE #1.

In operation 4, the P-CSCF may deliver, to the S-CSCF and the IMS AS (e.g., STAS), an SIP message including at least one of SIP Re-INVITE message request indication information (Re-INVITE request indication), changed AGW resource (e.g., IP address or port, or the like), and/or a SAT ID in order to request the IMS AS (e.g., STAS) to transmit an SIP Re-INVITE message for delivering, to a terminating-side network, AGW resource allocation information (e.g., IP address or port, or the like) within the changed satellite for supporting the IMS service of UE #1 due to the change of the satellite supporting UE #1.

In operation 5, the IMS AS, which has received, from the P-CSCF, an SIP Re-INVITE message request for delivering the AGW resource allocation information within the changed satellite to the terminating-side network, may determine an AGW resource change processing method based on the policy of a service provider. The IMS AS may not be able to support SIP message generation and transmission operations, based on an SIP re-INVITE transmission request message from the P-CSCF. In addition, if the corresponding service provider does not allow the corresponding operation (an operation of generating an SIP Re-INVITE message in the IMS AS) within the policy of the service provider, the IMS AS may determine an operation for delivering (forwarding), to UE #1, an SIP message including at least one piece of information among the SIP Re-INVITE message request indication information (Re-INVITE request indication), the changed AGW resource (e.g., IP address or port, or the like), and/or the SAT ID received from the P-CSCF.

In operation 6, an S-CSCF/TAS or the IMS AS may transmit the SIP message to UE #1. The SIP message may include at least one of a Re-INVITE request indication, AGW information, or a SAT ID. UE #1 may receive the SIP message from the S-CSCF/TAS or the IMS AS.

In operation 7, UE #1 may determine to generate an SIP Re-INVITE message, based on the SIP message received from the IMS AS in operation 6. When the SIP message received in operation 6 includes AGW resource allocation information (e.g., IP address or port, or the like) and/or a SAT ID within the changed satellite for supporting the IMS service of UE #1 due to the satellite change, UE #1 may generate an updated SDP offer, based on the corresponding information. If the SIP message received in operation 6 does not include AGW resource allocation information (e.g., IP address or port, or the like) and/or a SAT ID within the changed satellite for supporting the IMS service of UE #1 due to the satellite change, an SIP Re-INVITE message including an SDP offer related to a voice and/or audio call currently in use between UE #1 and UE #2 may be generated. UE #1 may deliver the generated SIP Re-INVITE message to the P-CSCF side.

In operation 8, when the SIP Re-INVITE message received from UE #1 in operation 7 includes AGW resource allocation information (e.g., IP address or port, or the like) and/or a SAT ID of the changed satellite related to UE #1 due to the satellite change, the P-CSCF may deliver the corresponding information to the S-CSCF and the IMS AS. If the SIP Re-INVITE message received from UE #1 does not include the AGW resource allocation information (e.g., IP address or port, or the like) and/or the SAT ID of the changed satellite related to UE #1 due to the satellite change, the P-CSCF may change the SDP offer, based on the AGW resource allocation information (e.g., IP address or port, or the like) and/or the SAT ID of the changed satellite related to UE #1 which is possessed by the P-CSCF, and may include the changed SDP offer in the SIP Re-INVITE message to deliver the corresponding information to the S-CSCF and the IMS AS.

The IMS AS may transmit the SIP Re-INVITE message including the AGW information within the changed satellite related to UE #1 (e.g., updated UE #1's serving AGW information) to an IS/-CSCF. The IS/-CSCF may deliver the SIP Re-INVITE message to the terminating-side network and a UE (UE #2). The AGW information within the changed satellite may include at least one piece of information among an AGW resource (e.g., IP address or port, or the like), and/or a SAT ID.

A terminating-side P-CSCF, which has received, from an originating-side network, the updated or changed AGW resource information (e.g., IP address or IP range, port, or the like) due to the change of the satellite supporting UE #1, may request information on a satellite supporting UE #2 from a terminating-side PCRF or PCF, and receive satellite-related information for supporting UE #2 from the PCRF or the PCF. If the terminating-side P-CSCF determines, based on the information received from the PCRF or the PCF, that the satellite supporting UE #2 has not changed, the terminating-side P-CSCF may deliver UE #1-related AGW resource information delivered from the originating side, and perform a connection configuration operation between an AGW supporting UE #2 and an AGW within the changed satellite supporting UE #1. If the satellite supporting UE #2 has changed based on the information received from the PCRF or the PCF, the terminating-side P-CSCF may determine to perform an AGW change operation related to UE #2, based on the satellite-related information received from the terminating-side PCRF or PCF. Thereafter, the terminating-side P-CSCF may request the changed AGW to deliver the changed UE #1-related AGW resource information received from the originating-side network, and to deliver the updated AGW information supporting UE #2 due to the change of the satellite.

In operation 9, depending on whether the satellite supporting UE #2 has changed, if the information on the satellite supporting UE #2 has been changed, the terminating-side network may deliver a 183 Progress or 200 OK message including AGW information within the changed satellite supporting UE #2 to the originating-side network. If the 183 Progress or 200 OK message delivered from the terminating-side network includes the changed AGW information supporting UE #2, an originating-side IMS AS may determine to generate a Re-INVITE message for delivering the changed AGW supporting UE #2 to an originating-side P-CSCF. Thereafter, the originating-side IMS AS may deliver the SIP Re-INVITE message including the changed AGW information supporting UE #2 to the P-CSCF, so that the changed AGW information supporting UE #2, received from the terminating-side network, may be delivered to the AGW within the satellite supporting UE #1 through an AGW resource update operation.

In operation 10, the UE may deliver a response message (ACK) to the 183 Progress or 200 OK message to the terminating-side network and the UE through the IMS AS, so as to notify that an IMS session update operation due to the change of the satellite on the UE #1 side has been successfully performed and completed.

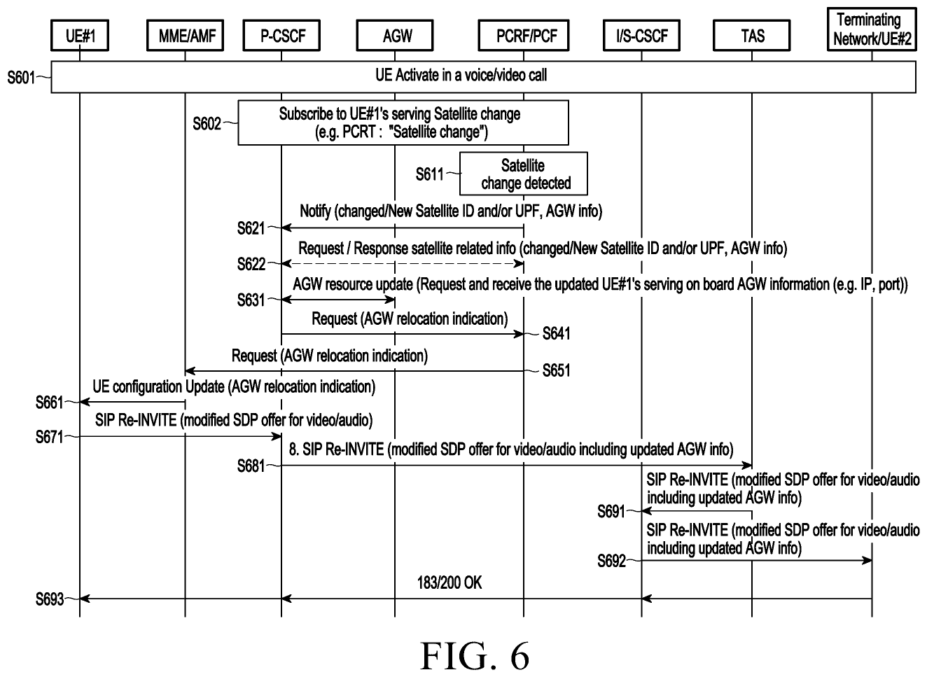

FIG. 6 is a flowchart illustrating an IMS session connection update operation considering movement of a satellite while a UE uses an IMS service using a satellite, according to an embodiment of the disclosure.

According to an embodiment of the disclosure, when a UE-to-UE communication service using a satellite (e.g., an IMS voice or video service) is used, a procedure for changing an IMS entity within the satellite (on board AGW relocation) due to movement of the satellite may be performed. A P-CSCF may deliver, to a PCRF or a PCF, a subscription request for information on a change of a satellite supporting a UE due to the movement of the satellite, so that when the satellite supporting the UE is changed by an AMF or an MME, the corresponding satellite change event occurrence information may be notified to the P-CSCF through the PCRF or the PCF.

In operation S601, each UE (UE #1 and UE #2) may request an IMS voice or video service connection and execute an IMS voice or video call through a UE-to-UE communication service using a satellite.

In operation S602, the P-CSCF, which has received information on a UE-to-UE communication service support indication using a satellite (UE-SAT-UE communication support indication) from the UE or an IMS AS (TAS) while performing an IMS service connection operation, may deliver a satellite change-related event subscription request (e.g., PCRT: “Satellite Change”) to the PCRF or the PCF.

In operation S611, depending on movement of the satellite, the PCRF or the PCF may detect a change of a satellite supporting UE #1, based on satellite change-related information (e.g., Satellite ID) received from the AMF or the MME. The UE may perform a mobility registration update (MRU), tracking area update (TAU), or service request (SR) operation to perform a connection to a new satellite supporting the UE depending on the movement of the satellite, and thus notify the AMF or the MME that a change of the satellite related to the UE has occurred. According to an embodiment of the disclosure, after receiving subscription request information of satellite change information from the P-CSCF, the PCF may deliver a policy control request trigger (PCRT) related to satellite change information to an SMF or the AMF, and when a PCRT condition (e.g., satellite change) is satisfied, the PCF may receive, from the SMF or the AMF, whether a corresponding event (a change of the satellite serving the UE) has occurred.

If, in operation S602, the P-CSCF has performed a subscription for a change event of the satellite supporting UE #1 to the PCRF or the PCF, the PCRF or the PCF may notify the P-CSCF of the satellite change event received from the AMF or the MME.

In operation S621, a notification message delivered from the PCRF or the PCF may include whether a satellite change event has occurred and changed satellite-related information. If the notification message delivered from the PCRF or the PCF includes the changed satellite-related information in operation S621, operation S622 may be omitted. In operation S622, the P-CSCF, which has received the notification message including only whether a satellite change event has occurred, may request information on the changed satellite supporting UE #1 (e.g., Satellite ID, and UPF and/or AGW information) from the PCRF or the PCF, based on UE #1-related information, and the PCRF or the PCF may deliver the information on the changed satellite supporting UE #1 (e.g., Satellite ID, and UPF and/or AGW information) to the P-CSCF.

In operation S631, the P-CSCF may perform an AGW resource update request operation on an AGW within the changed satellite, based on notification information on a change event of a satellite supporting a UE (UE #1) and information on a change of the satellite supporting the UE in operations S621 and S622. The P-CSCF may receive, from the changed AGW, resource allocation information (e.g., IP address or port, or the like) within the AGW for supporting an IMS service of UE #1.

In operation S641, the P-CSCF may deliver, to the PCRF or the PCF, a request message including indication information (Re-INVITE request indication or AGW relocation indication) for requesting the UE to transmit an SIP Re-INVITE message for delivering, to a terminating-side network, AGW resource allocation information (e.g., IP address or port, or the like) within the changed satellite for supporting the IMS service of UE #1 due to the change of the satellite supporting UE #1 through an EPC or a 5GC.

In operation S651, the PCRF or the PCF may deliver, to the MME or the AMF, the request message including the indication information (Re-INVITE request indication or AGW relocation indication) for requesting the UE to transmit the SIP Re-INVITE message for delivering, to the terminating-side network, the AGW resource allocation information (e.g., IP address or port, or the like) within the changed satellite for supporting the IMS service of UE #1, received from the P-CSCF.

In operation S661, the MME or the AMF may deliver, to the UE through a UE configuration update (UCU) message or the like, the indication information (Re-INVITE request indication or AGW relocation indication) for requesting the UE to transmit the SIP Re-INVITE message for delivering, to the terminating-side network, the AGW resource allocation information (e.g., IP address or port, or the like) within the changed satellite for supporting the IMS service of UE #1.

In operation S671, the UE (UE #1) may include, in the SIP Re-INVITE message, an SDP offer including information related to the IMS service currently in service, and deliver the message to the P-CSCF.

In operation S681, the P-CSCF, which has received, from the UE, the SIP Re-INVITE message including the SDP offer including the information related to the IMS service currently in service, may add AGW information (e.g., updated UE #1's serving AGW information) within the changed satellite for supporting the IMS service of UE #1 to the SIP Re-INVITE message, and deliver the message to the IMS AS (TAS) via an I/S-CSCF.

In operation S691, the IMS AS (TAS), which has received, from the P-CSCF, the SIP Re-INVITE message including the AGW information (e.g., updated UE #1's serving AGW information) within the changed satellite for supporting the IMS service of UE #1, may deliver the corresponding SIP Re-INVITE message to the terminating-side network and a UE (UE #2). If the SIP Re-INVITE message delivered by the UE does not include information on a UE-to-UE communication service support indication using a satellite (UE-SAT-UE communication support indication), the IMS AS (TAS) may add the information on the UE-to-UE communication service support indication using the satellite (UE-SAT-UE communication support indication) to the SIP Re-INVITE message, and transmit the message to an IS/-CSCF. The IMS AS may recognize that UE #1 uses the IMS service through a satellite connection, based on information (Access type or Cell id, or the like) in an SIP header received when UE #1 performs a registration procedure with the IMS network. Thereafter, if there is no UE-to-UE communication service support indication (UE-SAT-UE communication support indication) in an IMS service connection request message (SIP INVITE or SIP re-INVITE) received from UE #1, the IMS AS may add a UE-to-UE communication service support indication (UE-SAT-UE communication support indication) to the IMS service connection request message (SIP INVITE or SIP re-INVITE) in order to check whether the UE-to-UE communication service is supported by a peer network and UE. In addition, originating and terminating-side P-CSCFs may determine whether to perform an AGW resource update operation and an operation of requesting AGW information within a corresponding satellite, based on UE-to-UE communication service support indication (UE-SAT-UE communication support indication) information in an SIP message (SIP INVITE or re-INVITE or 200 OK), so as to perform a related operation. If an originating-side IMS AS adds the UE-to-UE communication service support indication (UE-SAT-UE communication support indication) to an SIP message (SIP INVITE or re-INVITE) and delivers the SIP message, but the terminating-side network transmits an SIP message (SIP 183 or 200 OK) which does not include the UE-to-UE communication service support indication (UE-SAT-UE communication support indication), the originating-side IMS AS may recognize that the terminating-side network and a UE cannot use a UE-to-UE communication service, and may perform an IMS service connection operation using a ground station. In operation S692, the IS/-CSCF may deliver the SIP Re-INVITE message to the terminating-side network and the UE (UE #2).

The terminating-side P-CSCF, which has received, from an originating-side network, the updated or changed AGW resource information (e.g., IP address or IP range, port, or the like) due to the change of the satellite supporting UE #1, may request information on a satellite supporting UE #2 from a terminating-side PCRF or PCF, and receive satellite-related information for supporting UE #2 from the PCRF or the PCF. If the P-CSCF determines, based on the information received from the PCRF or the PCF, that the satellite supporting UE #2 has not changed, the P-CSCF may deliver UE #1-related AGW resource information delivered from the originating side, and perform a connection configuration operation between an AGW supporting UE #2 and an AGW within the changed satellite supporting UE #1. If the satellite supporting UE #2 has changed based on the information received from the PCRF or the PCF, the terminating-side P-CSCF may determine to perform an AGW change operation related to UE #2, based on the satellite-related information received from the terminating-side PCRF or PCF. Thereafter, the P-CSCF may request the changed AGW to deliver the UE #1-related AGW resource information received from the originating-side network, and deliver the updated AGW information supporting UE #2 due to the change of the satellite.

In operation S693, depending on whether the satellite supporting UE #2 has changed, if the information on the satellite supporting UE #2 has been changed, the terminating-side network may deliver a 183 Progress or 200 OK message including AGW information within the changed satellite supporting UE #2 to the originating-side network. If the 183 Progress or 200 OK message delivered from the terminating-side network includes the changed AGW information supporting UE #2, the originating-side P-CSCF may deliver the changed AGW information supporting UE #2 to the AGW within the satellite supporting UE #1 through the AGW resource update operation. Thereafter, the originating-side P-CSCF may deliver the 183 Progress or 200 OK message to UE #1, so as to complete the performance of an IMS session update operation due to the change of the satellite.

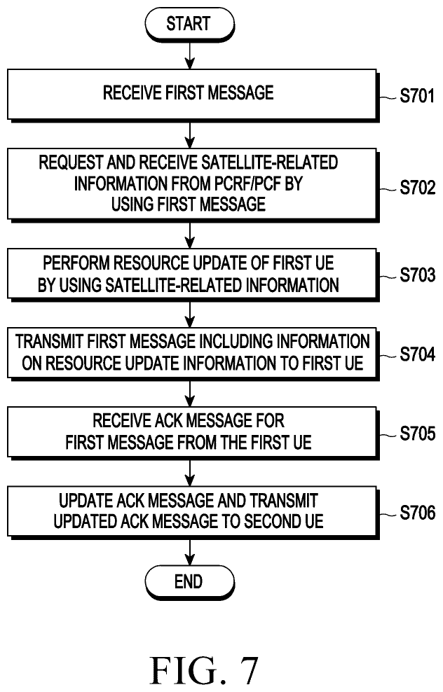

FIG. 7 is a flowchart illustrating an operation of an entity according to an embodiment of the disclosure.

Referring to FIG. 7, a second entity may include an I/S-SCSF. A first UE may include UE #1. A second UE may include UE #2. A second message may include a 183/200 OK message.

A first entity may receive a first message (S701, S311, and S403). The first entity may include a P-SCSF. The first message may include at least one of an SIP INVITE or an SIP Re-INVITE.

The first entity may request and receive satellite-related information from a PCRF/PCF by using the first message (S702, S404, S522, and S622). The satellite-related information may include at least one of a satellite ID, user plane function (UPF) information, or access gateway (AGW) information.

The first entity may perform a resource update of the first UE by using the satellite-related information (S703, S381, S407, S531, and S631). The resource update may include a resource update for a UE, an information update for a satellite, or an update related to a service session.

The first entity may transmit the first message including information on resource update information to the first UE (S704, S391, and S541). The information on the resource update information may include at least one of AGW reconfiguration indication information, changed satellite-related information, and information on a satellite.

The first entity may receive an ACK message for the first message transmitted by the first UE (S705, S392, S551, and S671). The ACK message for the first message may include an SIP Re-INVITE.

The first entity may update the ACK message and transmit the updated ACK message to the second UE (S706, S393, S551, and S671).

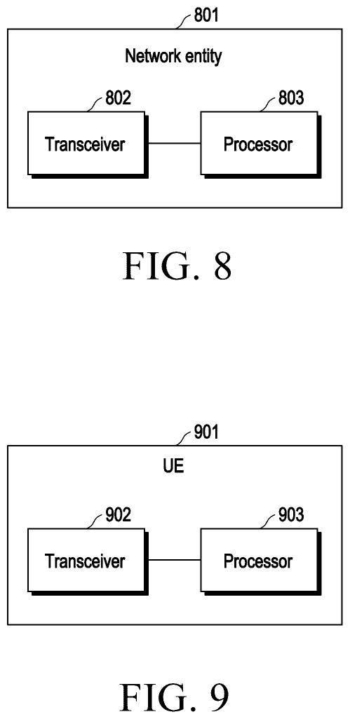

FIG. 8 is a block diagram illustrating a network entity according to an embodiment of the disclosure.

Referring to FIG. 8, a network system may include an entity. The network system may include a transceiver or a processor. In other words., the network entity device illustrated in FIG. 8 may be an entity (SMF, PCF, AMF, AF, NEF, UPF, RAN, or the like) device in the core network described in the disclosure.

The network entity 801 may include a transceiver 802 which performs signal transmission and reception with other network entities or UEs, and a controller 803 which controls the overall operation of the network entity 801. It will be appreciated that all the methods performed by entities, such as an AMF, a PCF, an AMF, an AF, an NEF, a UPF, and an RAN, are performed under the control of the controller 803.

Of course, the controller 803 and the transceiver 802 are not necessarily implemented as separate devices, but may be implemented as a single component unit, such as a single chip. The controller 803 may be implemented as one processor in the network entity 801.

FIG. 9 is a block diagram illustrating a UE device according to an embodiment of the disclosure.

Referring to FIG. 9, the UE 901 illustrated in FIG. 9 may be a UE device described in the disclosure. The UE 901 may include a transceiver 902 which performs signal transmission and reception with other UEs or network entities, and a controller 903 which controls the overall operation of the UE 901. It will be appreciated that all the operations or methods in the UE as described above in the disclosure are performed under the control of the controller 903.

Of course, the controller 903 and the transceiver 902 are not necessarily implemented as separate devices, but may be implemented as a single component unit, such as a single chip. The controller 903 may be implemented as one processor in the UE 901.

It should be noted that system configuration diagrams, method illustrations, and signal flowcharts illustrated in FIGS. 1, 2, 3A ,3B, 4, 5A to 5C, and 6 to 9 are not intended to limit the scope of protection of the disclosure. For example, all the constituent units or operations shown in FIGS. 1, 2, 3A, 3B, 4, 5A to 5C, and 6 to 9 should not be construed as essential elements for implementing the disclosure, and even when including only some of the elements, the disclosure may be implemented without impairing the true nature of the disclosure.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks, such as the Internet, Intranet, a local area network (LAN), wide LAN (WLAN), and storage area network (SAN) or a combination thereof. Such a storage device may access the electronic device via an external port. a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes and details may be made therein without departing from the spirit and scope of the disclosure as defined by the appended claims and their equivalents.

What is claimed is:

1. A method by a proxy-call session control function (P-CSCF) due to a change of satellites, the method comprising:
receiving, from a network entity, a notification of a satellite event, the notification including a satellite ID of a target satellite;
requesting an access gateway (AGW) to configure an internet protocol (IP) address allocated in a user equipment (UE); and
transmitting, to an IP multimedia subsystem (IMS) application server (AS), a first message associated with a session initiation protocol (SIP), the first message including the IP address allocated in the AGW and the satellite ID of the target satellite.

2. The method of claim 1, further comprising:
receiving, from the IMS AS, a response message including satellite information of a terminating network.

3. The method of claim 1, wherein the IMS AS is in an originating network, and the first message is for requesting for the IMS AS to transmit a second message associated with a SIP re-INVITE to a terminating network.

4. The method of claim 3, wherein the second message includes the IP address allocated in the AGW and the satellite ID of the target satellite.

5. The method of claim 1, wherein the network entity includes at least one of a policy control function (PCF), or a policy and charging rules function(PCRF).

6. The method of claim 1, wherein at least one of a voice media or a video media for the UE on satellite is forwarded through the IMS AS.

7. A method by an IP multimedia subsystem (IMS) application server (AS), the method comprising:
receiving, from a proxy-call session control function (P-CSCF), a first message associated with a session initiation protocol (SIP), the first message including the IP address allocated in the AGW and the satellite ID of the target satellite;
transmitting, to a user equipment (UE), a second message associated with a SIP re-INVITE.

8. The method of claim 7, further comprising:
receiving, from the UE, a response message including satellite ID of the satellite and an SDP answer.

9. The method of claim 7, wherein the IMS AS is in an originating network, and the first message is for requesting for the IMS AS to transmit the second message associated with a SIP re-INVITE to a terminating network.

10. The method of claim 7, wherein the second message includes the IP address allocated in the AGW and the satellite ID of the target satellite.

11. A proxy-call session control function (P-CSCF) due to a change of satellites, the P-CSCF comprising:
a transceiver; and
a processor coupled to the transceiver, wherein the processor is configured to:
receive, from a network entity, a notification of a satellite event, the notification including a satellite ID of a target satellite,
request an access gateway (AGW) to configure an internet protocol (IP) address allocated in a user equipment (UE), and
transmit, to an IP multimedia subsystem (IMS) application server (AS), a first message associated with a session initiation protocol (SIP), the first message including the IP address allocated in the AGW and the satellite ID of the target satellite.

12. The P-CSCF of claim 11, wherein the processor is further configured to:
receive, from the IMS AS, a response message including satellite information of a terminating network.

13. The P-CSCF of claim 11, wherein the IMS AS is in an originating network, and the first message is for requesting for the IMS AS to transmit a second message associated with a SIP re-INVITE to a terminating network.

14. The P-CSCF of claim 13, wherein the second message includes the IP address allocated in the AGW and the satellite ID of the target satellite.

15. The P-CSCF of claim 11, wherein the network entity includes at least one of a policy control function (PCF), or a policy and charging rules function (PCRF).

16. The P-CSCF of claim 11, wherein at least one of a voice media or a video media for the UE on satellite is forwarded through the IMS AS.

17. An IP multimedia subsystem (IMS) application server (AS) comprising:
a transceiver; and
a processor coupled to the transceiver,
wherein the processor is configured to:
receive, from a proxy-call session control function (P-CSCF), a first message associated with a session initiation protocol (SIP), the first message including the IP address allocated in the AGW and the satellite ID of the target satellite, and
transmit, to a user equipment (UE), a second message associated with a SIP re-INVITE.

18. The IMS AS of claim 17, wherein the processor is further configured to:
receive, from the UE, a response message including satellite ID of the satellite and an SDP answer.

19. The IMS AS of claim 17, wherein the IMS AS is in an originating network, and the first message is for requesting for the IMS AS to transmit the second message associated with a SIP re-INVITE to a terminating network.

20. The IMS AS of claim 17, wherein the second message includes the IP address allocated in the AGW and the satellite ID of the target satellite.
